(19) United States
(12) Patent Application Publication
(10) Pub. No.: US 2006/0028015 A1
(43) Pub. Date: Feb. 9, 2006

(54) Printable folding card assemblies and methods for forming folded cards and securing the folded portion

(76) Inventor: Gustav Allen Ray, Pacifica, CA (US)

Correspondence Address: Gustav Allen Ray, 36019 Pansy Road, Winchester, CA, 92596, US

(21) Appl. No.: 10/913,986

(22) Filed: Aug. 9, 2004

(51) Int. Cl. B42D 15/00

(52) U.S. Cl. 283/105

(57) ABSTRACT

A business card assembly for printing on with a desktop printer. The card assembly having two printable sides, and microperfs for defining business card subsections. Further each subsection has a first portion and a second portion. The first portion contains a tab for releasably attaching the business card first portion to the second portion.

### BACKGROUND OF THE INVENTION

Laser printers and ink jet printers have spawned a wide variety of options for personal printing that have not existed previously. A personal computer user can now prepare text and images on a word processing program and print the text and images directly onto print mediums that pass through the laser or ink jet printer. Such print mediums may consist of card stock with microperf lines for separating into individual business cards. The print mediums are typically 8 and ½ inches by 11 inches in dimension and are fed into the laser or ink jet printer through a standard paper tray. Printable inkjet and laser printable business cards and greeting cards are available from several companies including Avery Dennison. These cards are designed to run through a desktop inkjet or laser printer and then separated into individual portions by a microperfed line.

The present invention relates to folding card assemblies and methods for forming folded cards and securing the folded portion with the desired indicia printed on the cards thereof. It also includes methods for forming folded card asseblies with an attachement means for securing the folded card in the folded position.

Folded business cards create a custom look with added space for placing additional information about the company or product that the business card represents. Further, a folded card makes a memorable impression to anyone that receives it.

From the foregoing, there is the need to enable a user of a desktop printer in a personal computer system to print folded busines cards and the like with an attachement means for securing the card in the folded positon.

### SUMMARY OF THE INVENTION

Disclosed herein is an improved foldable card sheet or page with one or a series of configurable folding constructions including a means for securing the folded portion of the card.

The card sheet material is selected to accept and display clearly and cleanly indicia which is printed thereon by the printer, as desired by the user. After the indicia has been printed on the first side of the card material with a desktop laser or inkjet printer the sheet is removed from the printer and placed back in the printer tray for printing on the second side of the card sheet. To form the finished card after printing, the card material is released from the sheet by separating it along the lines of weakening. The released material is folded along a score line over onto itself and the distal end attached to the first face by an attachment means. Preferably the card material is pre-formed with a fold line on the sheet first face side thereof. Then with the card material folded on the line to form a folded card, the indicia is provided on both sides thereof, easily visible on both sides and easily secured to itself in order to keep the folded card in the folded position. The attachment means is such that the card remains folded but can be releasably attached allowing the user to unfold the card, refold and reattach the foldable card a plurality of times.

The card material can be provided the length (or a substantial portion thereof) of the sheet edge on the first and second faces thereof, and divided into segments along the edge. Indicia can be printed on each of the segments, and each can be selectively released, folded and attached to form separate cards. The segment selected will be at the desired location of the card along the edge. That is, according to a preferred embodiment the entire, for example, an 8 and ½×11 inch, sheet (or other printable sizes such as A4) which is passed through the printer or copier forms the end product, for example, a microperfed business card sheet. Further, the sheet after the printing operation on its cardstock material(s) is divided into separate smaller end products. They can be separated along lines of weakening such as microperforations, substantial cuts or through-cut lines, or a combination thereof. These lines of weakening are preferably preformed; that is, the sheets are provided to the user with the separation lines of weakening preformed therein defining the outlines of the smaller end products such as individual business cards. At least one of the edges of the products can be conveniently defined by one or more edges of the sheet, for example at the sheet corner.

Card material units are attached to the sheet as described above, to each of the sheet portions of the sheet, in an unfolded condition and in a flat sheet. When the sheet is subsequently passed through the printer or copier, the desired indicia is printed on each of the card material units, preferably on both sides of the card sheet. The printer or copier can be programmed to print the same or different indicia on each card unit on the sheet.

After the sheet has passed through the printer or copier and the indicia printed on the tab material units, the sheet is separated into its smaller end product units. Each is separated by pulling or tearing along its separation lines of weakening. A non limiting examples of a line of weakening is microperfs. After separation (or less preferably before), the card material unit is released from the sheet, folded on the score line and attached to itself. Thereby, a plurality of (smaller) products, each with its own indicia printed on one or both sides, can be formed from a single sheet. Preferred configurations of these products are a fold over business card, greeting card, name badge or ROLODEX.

An example of an attachement means for securing the card in the folded position is a slots on the first portion of the card for fitting tabs from from the second portion of the card into. Thereby releasably attaching the first portion of the card to the second portion of the card. To release the card from the folded position into the open position the tab is removed from the slot thereby releasing the first portion of the card from the second portion of the card. Other means of securing the cards in the folded position are pressure sensitive adhesive strips, velcro, cohesive adhesives, water activated adhesives and clips.

Other objects and advantages of the present invention will become more apparent to those persons having ordinary skill in the art to which the present invention pertains from the foregoing description taken in conjunction with the accompanying drawings.

### DETAILED DESCRIPTION OF PREFERRED EMBODIMENTS OF THE INVENTION

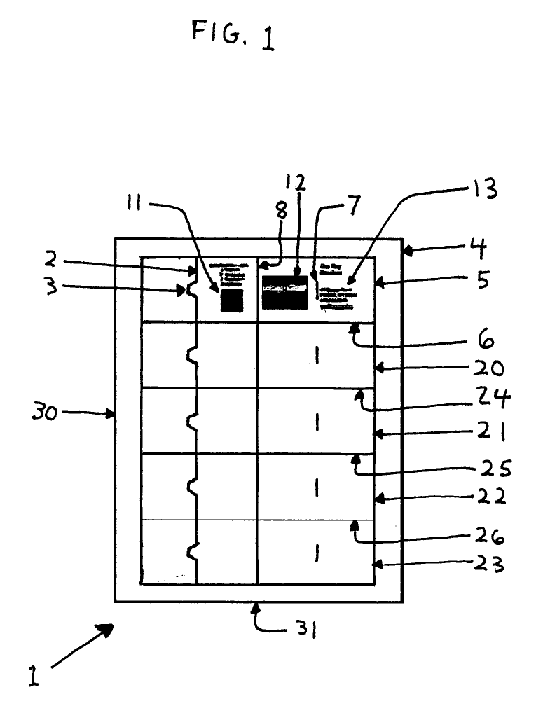

Referring to the drawings, a number of embodiments of the present invention are illustrated. One preferred embodiment is shown in FIG. 1 by the front side of a sheet assembly 1. The sheet assembly 1 preferably comprises paper, such as paperboard, cover stock, or Bristol paper available from manufacturers such as Champion or International paper. The paper is preferably 0.004 to 0.11 inch thick, is an 8 and ½ by eleven (or thirteen or fourteen) inch rectangle (or is International A4 size) and has a weight of 100-230 grams per square meter. These are the preferred dimension for printing with a desktop inkjet, electrophotographic or laser printer. An example of a preferred printer is the Laser Jet M printer available from Hewlett Packard. An example of printing on the surface of the sheet assembly is shown by the indicia 12. The sheet assembly is preferably subdivided into 4 cards as shown in FIG. 1. Each individual card is divided into two sections 11 and 13 and separated by a score line 8. A releasable tab 3 is die cut such that when the foldable card is removed from the sheet assembly 1 along the lines of weakening 5 and 6 and folded along the score line 8, the tab 3 can be inserted into the die cut 7 to secure the business card in the folded position.

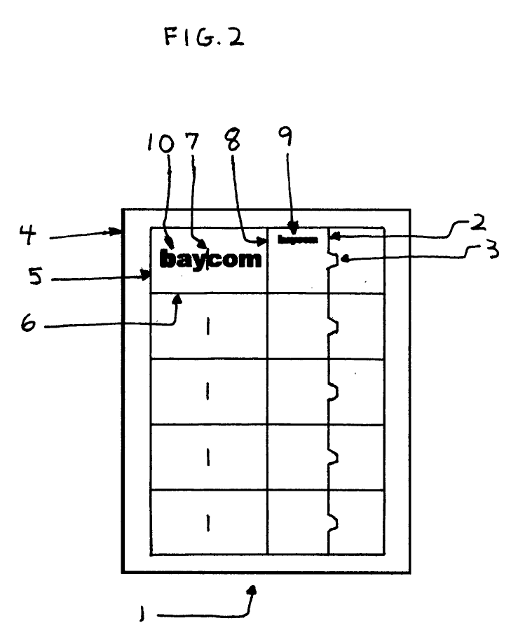

FIG. 2 is an elevational view of the opposite side of sheet assembly 1. The sheet assembly 1 is designed for printing on both sides of the sheet assembly. The indicia 9 and 10 show formatted printing in the correct orientation and location in respect to the first side as shown in FIG. 1.

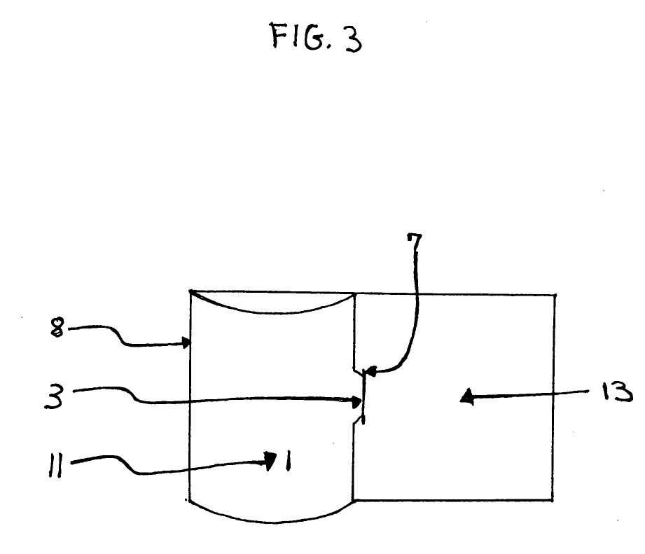

FIG. 3 is an elevational view of the business card removed from the assembly 1 shown with first side 11 and second side 13 folded along the score line 8 with with the tab 3 inserted into the slit 7 releasably attaching the folded card to itself. The score line 8 also allows for removal of folded portion 11 from the card by separating it along the score line 8.

An alternative embodiment includes using a releasable adhesive to maintain the business card in the folded position. An example of a removable adhesive is the UR-1 adhesive available from Avery Dennison. The removable adhesive releasably attaches the tab 3 to the business card face 1 as shown in FIG. 3 to the first or rear face 13 of the business card as shown in FIG. 3. The removable adhesive is applied to the flexible assembly sheet material with a coating on only the tab portion 3. To facilitate printing, a release liner may be applied to the adhesive on the tab portion 3.

Further, an alternative embodiment has a permanent pressure sensitive adhesive such as P-9 adhesive available from Avery Dennison to attach the first side 11 to the second side 13. The permanent adhesive is applied to the flexible assembly sheet material with a coating to facilitate printing a release liner may be applied to the adhesive on the sheet.

The sheet assembly 1 is subdivided according to one preferred embodiment, That is, these lines of weakening 2, 5, 6, and 20-26 extend perpendicular to the edge 30 of the sheet assembly 1 and across the full width of the material 31 and divide the material into segments 11 and 13. A score line 8, parallel to edge 30, divides the foldable business cards into first and second sections 11 and 13 to facilitate subsequent folding in a later formation step. Further section 11 can be separated from the folded card along score line 8. A non limiting use for the separated portion is a coupon.

The consumer using commonly available software, such as Word available from Microsoft, causes a desktop printer to print indicia. Examples of printed indicia are shown FIG. 1 and FIG. 2 with the indicia 9, 10 and 12 on specific segments of the sheet assembly 1 including the back side as shown in FIG. 2. Some or all of the individual subsections may be printed, as shown in FIG. 1 and FIG. 2.

Following printing, the user releases the desired segment by seperating it along the lines of weakening such as lines 2, 5 and 6 from the sheet assembly 1. He then rotates the first section 11 towards the second face 13 and folds it on the score line 8. The tab portion 3 is inserted into the slit 8 with the tab portion sliding into the slit in the back face proximate to the middle as shown in FIG. 3. A securely folded card is thereby formed with properly oriented indicia 10, 11 and 12 on the front and rear business card faces.

The same indicia can be printed by a desktop printer on all segments as shown, or different indicia can be printed on each. Color coding and other visual indexing cues, as known to those skilled in the art, can also be used to provide further user convenience for folding the card.

Again, by releasing, folding and attaching, a sturdy card, attractively printed on both faces thereof can be created by the consumer using common personal computing and printing hardware and software. More than one of these smaller end products can be formed from a single sheet assembly 1, and a preferred smaller end product is a business card, greeting card, name badge or ROLODEX type card.

Another embodiment of this invention includes only a portion of the sheet as the end product. That is, and referring to FIGS. 1-3, after the sheet assembly 1 has been passed through the desktop printer, a subsection of the sheet is separated away from the rest of the sheet. The subsection is then released, folded and reattached similar to the process as described previously to form the printed card.

Perforated lines 2, 5, 6 and 20-26 in the sheet assembly 1 define the subsections of the sheet assembly perimeter not coincident or defined by the sheet edges. The portion of the card material on one face of the sheet is divided into sections by a score line or line of weakening 8. Additional information is then printed on the opposite side of the card sheet. That card material portion is then released, folded and attached, as previously described, to form a folded card.

The printable card assembly can be a sheet of paper such as ten mil thick cardstock available from Simpson Paper Mill in Pomona, Calif. The paper sheet assembly 1 can have a thickness of preferably between six or seven and twenty mils, and a weight of between sixty and one hundred fifty pounds. Alternatively, the sheet can be a fifty-seven pound vellum bristol, approximately 7.5 mil thick, such as that available from Wausau or Champion, or ninety pound index paper, approximately seven mil thick, such as that available from International Paper.

The microperforations or lines of weakening 2, 5, 6 and 20-26 consist of cuts which vary in size from 0.0125 to 0.0135 inch and which are separated by ties that vary in size from 0.0045 to 0.0050 inch. Thus, there are between fifty-three and fifty-nine perforations per inch, with about fifty-six perforations being an average therebetween. However, it is also within the scope of the invention for the perforations to be only thirty-five perforations per inch, or in the range of from thirty-five to fifty-nine perforations per inch. The diecut lines or lines of weakening 3 and 7 are preferably diecut through the entire thickness of the sheet assembly 1 to aid in separating the subsection from the sheet assembly.

After the printing operation but preferably before this card forming procedure, the card(s) is (are) separated from the rest of the sheet assembly 1. By pulling along the perforation lines 2, 5, 6 and 20-26 (and thereby) breaking the ties, the card separates out easily, quickly and accurately. Each of the four subsections of the sheet assembly 1 are separated out and its individual folded card formed. The remainder of the sheet assembly 1 can be discarded, if desired.

Other attachment means, shapes and arrangements of foldable cards defined on the sheet can be provided as would be apparent to those skilled in the art. Each card should preferably about ¾ of a sheet edge so that the subsections can be folded easily and attached to itself. Instead of business cards, flip-file cards, greeting cards, name badges, ROLODEX cards, index tabs and other smaller end products can be formed from a single larger sheet, as would be apparent to those skilled in the art.

Method

The present invention also provides a method of making a folded card product with an attachment means to secure the card in the folded position. This method comprises loading at least one the substrates 1 into a desktop printer, preferably an ink jet or laser printer, and printing indicia on said substrate with personal computer system

The method further comprises printing, with the desktop printer on the front and back of the card as shown in FIG. 1 printed indicia 11 and 12. The individual sections are then removed and assembled as shown in FIG. 3.

From the foregoing detailed description, it will be evident that there are a number of changes, adaptations and modifications of the present invention which come within the province of those skilled in the art. However, it is intended that all such variations not departing from the spirit of the invention be considered as within the scope thereof as limited solely by the claims appended hereto.

I claim:

1. A business card print media for desktop printers, comprising:
(a) an opposite first and second faces, an edge;
(a) lines of weakening defining a plurality of business card sections;
(c) score lines defining fold lines and subsections; and
(d) a tab and slot attachment means for removably attaching one subsection to the other subsection of the folded business card.

2. The improvement of claim 1, wherein the print media contains an inkjet ink receptive coating.

3. The improvement of claim 1, wherein the print media contains a toner particle receptive coating.

4. The improvement of claim 1, wherein the score lines consist of microperfs.

5. The improvement of claim 1, wherein the lines of weakening define four individual fold over business cards.

6. The improvement of claim 1, wherein the lines of weakening are microperfed

7. The improvement of claim 1, wherein the lines of weakening are partial cuts.

8. The improvement of claim 1, wherein the fold line defines a horizontal fold line.

9. The improvement of claim 1, wherein the fold line defines a vertical fold line.

10. The improvement of claim 1, wherein the score lines consist of partial cuts.

11. The improvement of claim 1, wherein the folded business card dimensions are 3 inches by 2.5 inches.

12. The improvement of claim 1, wherein the unfolded business card dimensions are 3 inches by 4 inches.

13. The improvement of claim 1, wherein the unfolded business card dimensions are 5 inches by 2.5 inches.

14. The improvement of claim 1, wherein the slot is a die cut line one half inch in length.

15. The improvement of claim 1, wherein the tab is a semicircle with a half inch diameter.

16. A print media, comprising:
(a) an opposite first and second faces and an edge; and
(a) lines of weakening defining a plurality of sections; and
(c) score lines defining subsections within each section; and
(d) attachment means for releasably attaching one folded subsection to the other.

17. The improvement of claim 16, wherein the attachment means is a tab and slot.

18. The improvement of claim 16, wherein the attachment means is a pressure sensitive adhesive.

19. The improvement of claim 16, wherein the attachement means is a removable adhesive.

20. The improvement of claim 16, wherein the attachement means is a cohesive adhesive.

21. An assembly, comprising:
a printer or copier;
print media having opposite first and second faces and an edge;
fold over business card material having first and second portions, the first portion being releasably attached to the second portion; and
means for feeding the business card material in a printer or copier feed position wherein the first and second portions are on the first face and (b) after the print media with the business card material in the feed position has passed through the printer or copier, in a busiess card position wherein the first portion is attached to the second poriton with a releable attaching means.

22. An assembly, comprising:
print media having opposite first and second faces and an edge;
fold over business card material having first and second portions;
the first portion being secured to the second portion; and
means for releasably attaching the first and second portions including means for allowing manual release thereof from the first face after a printing operation by a printer or copier and for attaching the released first and second portions together in a back-to-back relation extending out from the edge.
